(19) United States
(12) Patent Application Publication
(10) Pub. No.: US 2007/0092615 A1
(43) Pub. Date: Apr. 26, 2007

(54) Container rim attachment with pre-applied applique

(75) Inventors: Wallace K. Fisk, North Oaks, MN (US); Kelly J. Mitchell, North Oaks, MN (US); Paul C. Thompson, Excelsior, MN (US); Matthew W. Lorence, Plymouth, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(73) Assignee: K Cups, LLC

(21) Appl. No.: 11/378,912

(22) Filed: Mar. 17, 2006

Related U.S. Application Data
(63) Continuation-in-part of application No. 11/254,900, filed on Oct. 20, 2005.

(51) Int. Cl. G07F 13/06

(52) U.S. Cl. 426/416

(57) ABSTRACT

A container rim attachment has a pre-applied appliqué. The container rim attachment comprises a carrier with an outer surface and a rim-receiving recess. An attractant appliqué is applied to the outer surface of the carrier such that there is an adherence between the appliqué and the outer surface. The adherence between the appliqué and the carrier is sufficient to withstand conditions associated with shipping, storage, or handling of the carrier and appliqué without substantial appliqué degradation. The appliqué may be an edible appliqué for use with beverage containers.

### CROSS-REFERENCE TO RELATED APPLICATION

The present application is a continuation-in-part of U.S. patent application Ser. No. 11/254,900, which was filed on Oct. 20, 2005, and is hereby incorporated in its entirety into the present application.

### FIELD

The present invention relates generally to beverage containers with an appliqué applied thereto. More specifically, the present invention relates to beverage containers having an edible appliqué applied thereto by a rim attachment or directly to the rim, the appliqué being prepared at a time that is significantly prior to the time of consumption.

### BACKGROUND

Many types of drinks are served in a glass having a rimmer that adds a flavor dimension and/or eye appeal. For example, a margarita is served in a glass having a salt rimmer, a daiquiri is served in a glass having a sugar rimmer, a bloody mary may be served in a glass having a spice rimmer, etc. Rimmers are also considered a way to add flavor to: bellinis, martinis, cosmopolitans, and pina coladas; non-alcoholic cold drinks, such as iced tea, lemonade and milk; and hot drinks such as coffee and cocoa. Typically, the rimmer is prepared on the glass or cup at the location where the drink is served. More specifically, the rimmer is generally applied to the glass when the drink is being mixed and just before it is served. Thus, the rimmer is applied at approximately the time of consumption and is not “pre-applied” to the container.

Traditionally, the margarita-type rimmer is applied by wetting the rim with a lime wedge and immediately placing it in a bed of salt. The wet lime juice provides sufficient adhesion to retain the salt, at least temporarily. Alternately, the rim may be wet with water and then placed in a bed of salt. The salted rim resulting either from lime juice or water wetting of the rim is typically not durable and may fall off as the drink is handled and the juice or water dries. For other drinks, fruit juice or water provides the wetting, and a wide variety of salt, sugar, spice and flavor particle mixes are used for the bed in which the wetted rim is placed.

In a commercial setting, glass rimming adds steps to a drink preparation process that may already be complex. In a busy bar or at hotel receptions and similar functions with large numbers of people to serve, rimming glasses may slow service time unacceptably. Moreover, the materials and equipment used for rimming provide another set of sanitation issues. In a non-commercial setting, rimming glasses is often considered burdensome and overly time-consuming. It is best done with a special tray for holding wetting and rimming material. A host of a party may not rim the glass of each margarita served because of the time associated with setting up the rimming materials and performing the rimming. Further, a sponge is typically used to apply the wetting agent (e.g., juice, water) to the rim of the glass. Such sponge is typically not sanitized over the course of a day (or a party) and microbiological contaminants may become of concern. After several usages, the bed of salt or other rimming material may also be degraded by clumping, and any wetting agent present in the bed may make that material a further possible source of microbiological contaminants.

Plastic cups are not generally considered suitable for rimming. Most plastics used for beverage containers are hydrophobic. Thus, plastic has a low affinity for water, does not wet well, and repels water-based liquids such as lime juice. When lime juice or water is applied to plastic, the liquid forms discontinuous droplets. These droplets retain very little salt when the rim is placed in a bed of salt. Additionally, the dried liquid/salt residue does not typically adhere well to the surface of plastic. One manufacturer has addressed this with a rimming syrup (under the trademark RoxiSpice) which the seller claims “keeps the salt or spice on your plastic glasses for a more attractive presentation.” The rimming syrup and salt or spice are applied approximately at the time of consumption. Listed ingredients for the RoxiSpice product are: high fructose corn syrup, water, propylene glycol, polysorbate 60, xathan gum, malic acid, sodium benzoate, propylene glycol alginate, potassium sorbate.

When a rimmed beverage glass is served, the rimmer is typically functional for flavoring and provides limited eye appeal unless very carefully done. An improved method for providing attractive rimmed beverages would be desirable.

### BRIEF SUMMARY

A container rim attachment having a pre-applied appliqué is provided. The rim attachment has a carrier with an outer surface and a rim-receiving recess. There is an attractant appliqué applied to the outer surface of the carrier such that there is an adherence between the appliqué and the outer surface. The adherence between the appliqué and the carrier is sufficient to withstand conditions associated with shipping, storage, or handling of the carrier and appliqué without substantial appliqué degradation.

While multiple embodiments are disclosed, still other embodiments of the invention will become apparent to those skilled in the art from the following detailed description, which shows and describes illustrative embodiments of the invention. As will be realized, the invention is capable of modifications in various obvious aspects, all without departing from the spirit and scope of the invention. Accordingly, the drawings and detailed description are to be regarded as illustrative in nature and not restrictive.

### BRIEF DESCRIPTION OF THE DRAWINGS

FIGS. 1a and 1b illustrate in cross-sectional side and top views, respectively, a container having an appliqué pre-applied to the rim thereof in accordance with one embodiment of the present invention.

FIG. 1c illustrates a cross-sectional side view of a container having an appliqué pre-applied to a portion thereof in accordance with a further embodiment of the present invention.

FIGS. 2a-2f illustrate various embodiments of suitable containers with rim appliqués applied using the present invention.

FIGS. 3a-3e illustrate various embodiments of rims of a container for receiving a pre-applied appliqué in accordance with one embodiment of the present invention.

FIGS. 4a-4c illustrate schematically methods for placing appliqués in two parts in accordance with the present invention.

FIGS. 5a-5b illustrate schematically manufacturing methods for placing appliqués on a container (only partially shown) in accordance with the present invention.

FIG. 6 illustrates a container with a patterned appliqué of two colors.

FIGS. 7a-7c are top, cross-section and side views of a rim attachment with appliqué, with FIG. 7c also showing a container to which the rim attachment is affixed.

FIGS. 7d-7f are cross-sectional detail views of three rim attachments with appliqué, showing different profiles and showing a mating between the profiles and the rim of a container to which the rim attachment is affixed.

FIGS. 8a-8c show different forms of rim attachments (cut ring, coil and linear segment) that are adaptable to different container rim circumferences.

FIG. 8d shows in cross section the nesting of rim attachments whereby the appliqué of one nests against the rim receiving recess of the one above it.

FIGS. 9a-9b show two different rim attachments with decorative features in the carrier walls.

### DETAILED DESCRIPTION OF THE DRAWINGS

Overview of Appliqué Placed on Container. A container having a pre-applied edible appliqué is provided. The container, thus, has an appliqué that is applied thereto at a time that is significantly prior to the time of consumption.

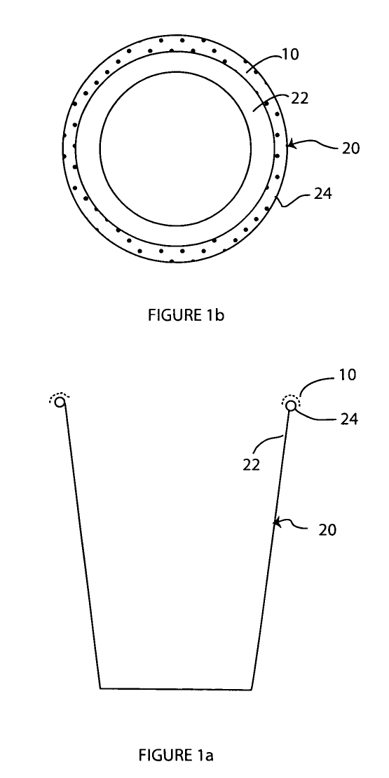

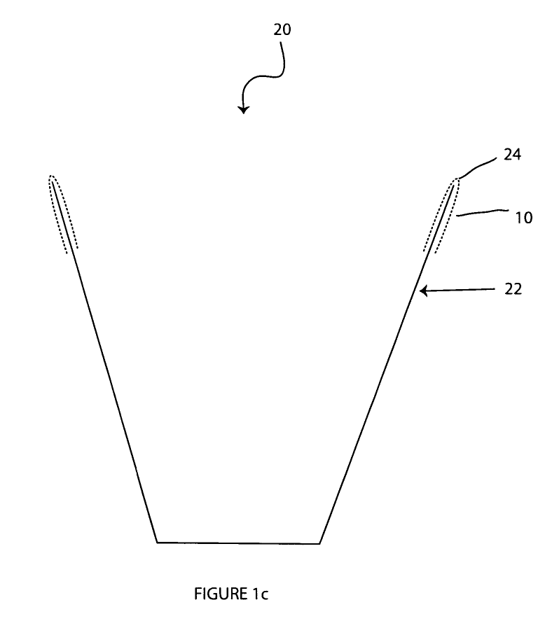

FIGS. 1a, 1b, and 1c illustrate embodiments wherein the appliqué is pre-applied and bonded to the rim 24 at or around the upper edge of side wall 22 of the container 20. This embodiment may be useful, for example, in the beverage industry. The appliqué 10 may encircle the entire rim 24 or be present on only a portion of it, to offer the user sipping without encountering the appliqué. In alternative embodiments, the appliqué may be applied to other portions of the container in lieu of or in addition to the upper rim 24 of the container 20. As shown in the embodiment of FIG. 1c, the appliqué 10 may coat a portion of the interior and the exterior of the container and may extend over a portion of the container greater than the upper rim, for example extending 0.5 to 1 inch away from the upper rim of the container.

Containers. As shown in FIGS. 1a-1c, the container 20 is a beverage container. The beverage container 20 may be formed of any suitable material, and the material may be determined based on the purpose of the beverage container. For example, the container 20 may be formed of glass or ceramic material such that the container may be used after an initial use. Thus, for example, the container may be purchased with a rimmer appliqué 10 pre-applied. Initial use of the container, thus, includes usage with the pre-applied rimmer. After this use, the container 20 may be washed and used as a container without a rimmer.

The container may be formed using any suitable process. For example, the container may be formed by conventional glass, ceramic, plastic, or metal manufacturing methods, with the appliqué added as a food processing step after or during manufacture of the container. The appliqué is added at a time and location other than the time and location of consumption.

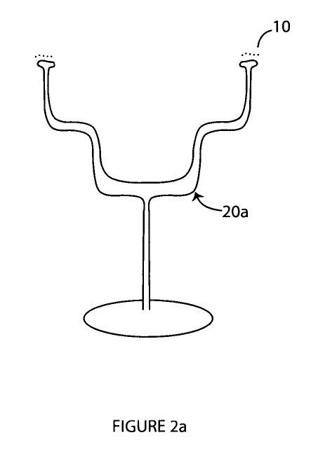

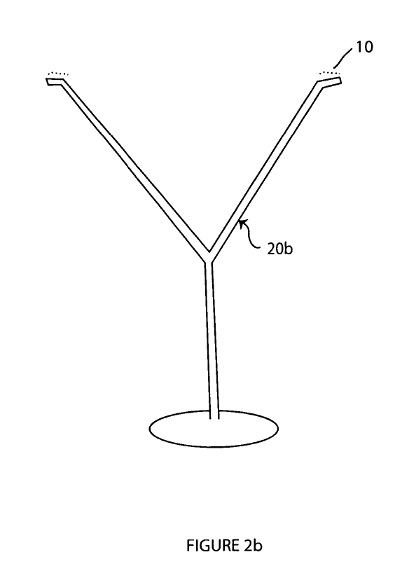

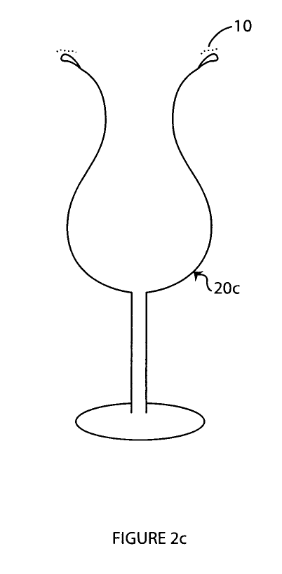

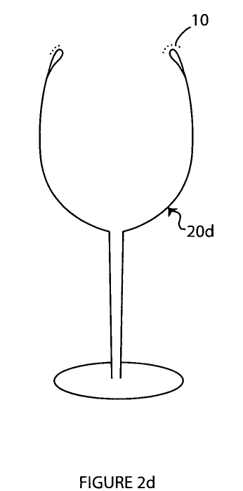

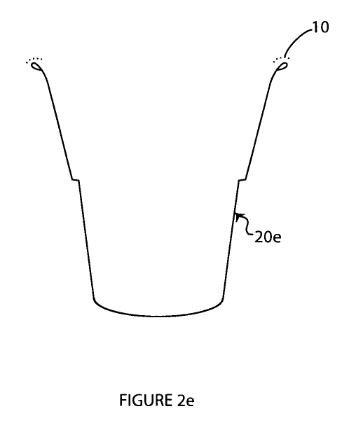

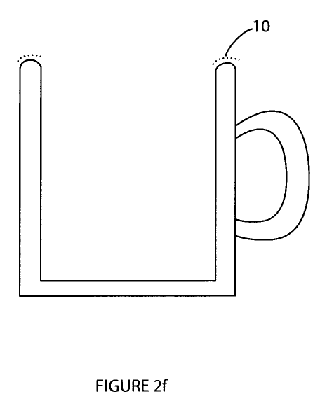

The container 20 may be formed of a plastic material (such as polypropylene, polyester, polystyrene, or high density polyethylene). The container 20 may be formed with common processes such as thermoforming or injection molding and configured in any suitable manner. Thus, for example, the container 20 bearing a pre-applied appliqué 10 may be shaped as a margarita glass 20a (shown in FIG. 2a), a martini glass 20b (shown in FIG. 2b), a daiquiri glass 20c (shown in FIG. 2c, a wine glass 20d (shown in FIG. 2d), a standard cup 20e (shown in FIG. 2e), a coffee mug 20f (shown in FIG. 2f), or any other suitable shape. For example, the container also may be a bowl, tray, plate, platter, or other food service vessel.

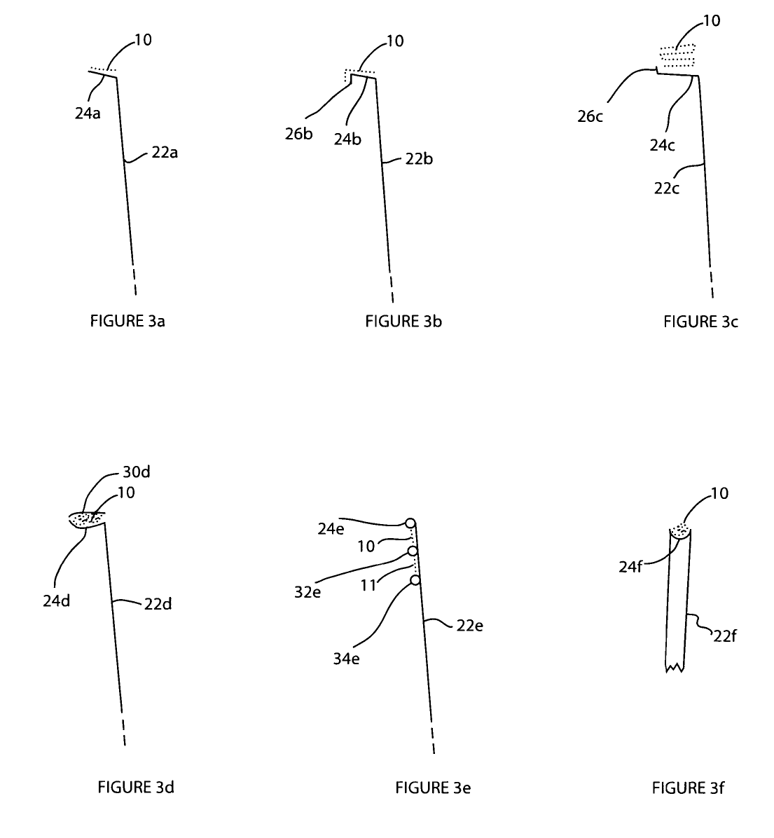

Rim Configurations. The rim of the container 20 may be provided with an enhanced surface area, shape, or volume for receiving the appliqué. As shown in FIG. 1, an enlarged rim is provided by rolling a top portion 24 of the container side 22. FIGS. 3a-3e illustrate alternate embodiments of container rims. These can help to hold the appliqué, in particular to accommodate and hold an increased volume of the rimmer material. Thus, the rim may be modified to hold more or less by any suitable configuration. Rim shape may also address sipping comfort of the drinker. Most plastic thermoformed drinkware typically comprises a rolled edge as a rim.

In FIG. 3a, the rim comprises a generally planar extension 24a from the container 20. The rim of FIG. 3b correlates closely to the rim of FIG. 3a and further comprises a downward extension 26b from an end of the planar extension 24b. The rim of FIG. 3c has a planar extension 24c with a small upward extension 26c, which together serve as a platform for a substantial amount of appliqué in a ring on the rim. The rim of FIG. 3d comprises a trough-like rim 24d, which may be formed by a generally concave extension from the container side wall 22d. Such trough-like rim may alternatively be provided in a container wall having a thickness for supporting the trough, for example, the container of FIG. 2f. This configuration is shown in FIG. 3f, wherein the concave rim 24f is provided in the wall 22f.

The appliqué 10 may be applied to any surface of the rim structures. Thus, for example, the appliqué may be applied to the top surface and/or the side or bottom surface of the extensions. Referring again to FIG. 3d, a protective film 30d may be applied over the appliqué to protect it and keep it sanitary. (This is equally applicable to other embodiments shown, although not depicted on others). In FIG. 3e, the rim is a rolled rim 24e as in FIG. 1 or a beaded rim and the container further comprises a raised annular surface or secondary rim 32e along the container side wall 22e spaced from and parallel with the rim 24e. This principle can be extended to provide a tertiary rim 34e or a sequence of ribs, closely spaced as parallel circles descending from the rim 24e. The appliqué 10 thus may be applied on the rim and/or between the rim 24e and the raised surface 32e or between raised surfaces 32e and 34e. Additional appliqué attractant material or a second, different appliqué 11 may be applied between secondary and tertiary raised surfaces 32e and 34e. In FIG. 3f, a thick-walled container, such as a mug, is shown with appliqué held in a concave rim 24f. These figures are intended to illustrate various suitable configurations and are not intended to be limiting.

Bonding. The pre-applied appliqué in one embodiment is used on a disposable container that will be manufactured and then shipped to a point of use. Here the appliqué must be bonded to the rim in such a way that it can survive shipping and handling as well as storage necessary before it is actually used without substantial degradation by loss of rimming material. The bonding should be sufficiently durable to withstand both the handling aspects of shipping, handling, and storage and the time aspects of shipping, handling, and storage (days, weeks or months, typically). The bond must be effective for the appliqué to survive with its food and eye-attractant attributes substantially retained under most shipping and handling conditions with relatively standard forms of packaging and shipping containers as used for disposable or non-disposable beverage containers. Thus, for example, the applied appliqué should be sufficiently durable to provide stability through distribution, ambient condition changes, and exposure to humidity as well as resistance to fracture and erosion when torsion is applied to the containers. One measure of effective bonding is to test the bonding in accordance with ASTM D4169 Standard Test Method for Testing of Shipping Containers and Systems. Using testing as described in the protocol of ASTM D4169, the containers with pre-applied appliqué should be able to withstand shipping conditions without substantial degradation. The bonding should also be suitable for withstanding, for example, end user (server and consumer) handling. Generally, the bond should allow some flexing of the container without significant flaking of the appliqué from the container. Further, the bond preferably does not become tacky in humidity but is not so dry as to flake.

In one embodiment, the appliqué is formed in two parts; an adhesive substrate that will both adhere to plastics (such as a corn syrup and malto-dextrin mixture further described below), and that will also be effective to receive and hold particulate appliqué attractant material (flavoring and/or decorative) applied in a second step, once the adhesive substrate is placed on the container. In another embodiment, the appliqué is a single composition, which contains both the adhesive and the flavoring or decorative material. This material may be either particulate or liquid and substantially homogeneously distributed in a mixture used as the appliqué. In a third embodiment, the appliqué is of a kind that itself can be applied to the container without separate adhesive, e.g., chocolate. Curing may be used to help enhance the bond of appliqué and/or of the appliqué attractant material in any separate adhesive substrate to a container rim. Curing methods depend on the particular materials used (discussed below).

The surface of the container to which the appliqué is applied may further be pre-treated for increasing adhesion of the appliqué. For example, in the embodiment of FIG. 1, the rim of the container may be pretreated. Such pretreatment may include roughening the rim surface or at the time of manufacture, creating ribs, cross-hatching or other texture of the rim area to aid holding the appliqué attractant material. Further, the surface of the container may be chemically or electronically pre-treated to make the surface molecules more receptive to bonding.

While the bond of the appliqué to the adhesive and the adhesive to the container establishes the majority of the desired physical characteristics, for example, that the appliqué and adhesive have some flexibility, be durable, have minimal stickiness, be effectively dried to discourage bio-burden growth, etc., these characteristics may be enhanced or preserved through packaging. For example, moisture barrier packaging may be used to limit exposure of the containers to humidity that may be re-absorbed. Thus, the bond need only withstand humidity that would penetrate moisture barrier packaging. Containers may be individually wrapped or, for greater efficiency in volume use, wrapped in nested stacks. Containers or bags of multiple items may be re-closeable and/or of materials that do not readily adhere to adhesives or appliqués used.

Appliqué Attractant Materials. The appliqué may incorporate any suitable material that makes the container 20 and its contents when filled more attractive. Thus, the appliqué attractant material may impart pleasing sensory qualities, including flavor, texture, mouth feel, smell, and/or color or patterns. Generally, the appliqué is edible. The appliqué may thus impart nutritional, nutraceutical or therapeutic value. The appliqué thus may be a salt, sugar, spice, spice mixture, nut, seed, fruit, vegetable, herb, flower, candy, nutraceutical, vitamin, or medicine. Specific examples include nutmeg, cinnamon, chocolate, pomegranates, olives, mint, coconut, orchids, gardenias, hibiscus, flavored sugar. Further, the appliqué may be provided as finely ground, crushed, chopped, or whole pieces.

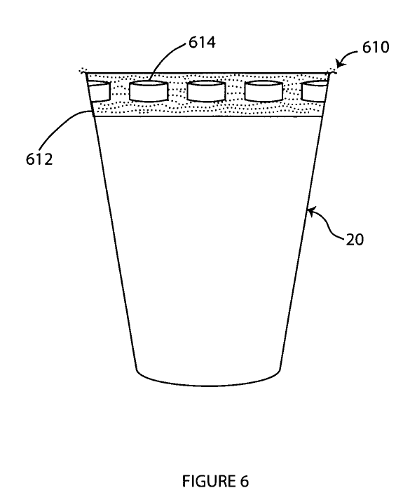

In addition to use as a rimmer with food appeal, the appliqué may also be used as a decoration, primarily an eye attractant. For example, the appliqué may be colored or patterned. Thus, for example, containers having appliqués applied thereto, may be mass-produced for sporting events with the appliqués provided in team colors, with or without shapes or patterns, e.g., footballs, hockey pucks. FIG. 6 shows container 20 with appliqué 610, consisting of a background team color band of salt or sugar crystals 612 with hockey puck images 614 formed in crystals in a second team color patterned in or overlaid.

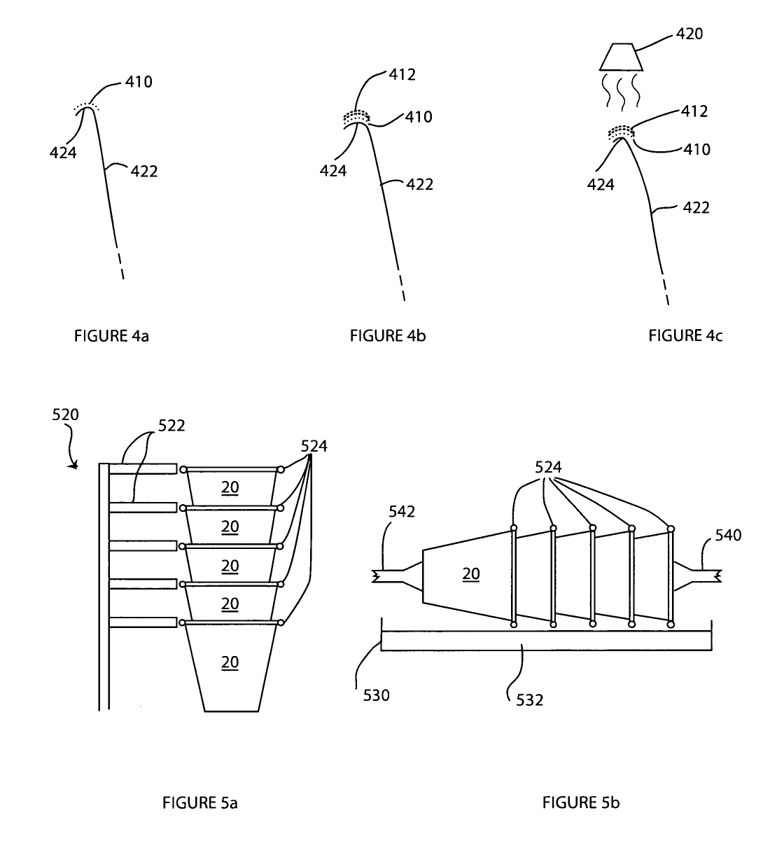

Placement of Appliqués. As noted above, the appliqué may be applied to the container in any suitable manner such that adhesion or bonding is effective between the appliqué and the container. In one embodiment shown in FIGS. 4a-4c, an adhesive substrate 410 is applied to the container rim 424 and the appliqué 412 is applied to the adhesive. A curing means 420 to apply heat, drying, cooling or other curing effect appropriate to the adhesive substrate 410 and appliqué 412 may be used.

Any suitable adhesive may be used but should provide sufficient adhesive properties to impart durability to the bonding of the appliqué to the container. In application of an appliqué to a beverage container or other food container, the adhesive should be edible or be of a material approved for food contact. Suitable adhesives include materials in categories such as starches, gums, sugars, fats, proteins, and pectin. More generally, the adhesive may be any suitable carbohydrate-based, lipid-based, protein-based, or other adhesive. Specific carbohydrate-based examples include maltodextrin, xanthan gum, carboxymethylcellulose, modified starch, and corn syrup. Thus, the adhesive material may be flavor or color neutral (i.e., negligible discernible flavor) or have its own attractant qualities (e.g., vanilla flavor, red coloring) separate from the appliqué attractant material that it holds. The adhesive material may further be selected and configured to complement the taste of the appliqué.

In one embodiment, an adhesive is used that is tacky with a relatively high viscosity, such that the adhesive may be effectively applied to the container and the appliqué attractant material applied to the adhesive before the adhesive can bead up and become discontinuous. The adhesive dries rapidly and retains sufficient tackiness and flexibility to provide durability during shelf-life and transport. For example, such adhesive may be a maltodextrin-corn syrup blend. The blend may range, for example, from approximately 50% malto-dextrin solution and 50% corn syrup, by weight, to approximately 75% malto-dextrin solution and 25% corn syrup, by weight.

If malto-dextrin is used in the adhesive, the malto-dextrin is hydrated to a desired level of viscosity. In one embodiment, the malto-dextrin is hydrated to a viscosity approximately similar to the viscosity of corn syrup. The malto-dextrin may be hydrated with water or may be hydrated with a solution. For example, the malto-dextrin may be hydrated with a solution that imparts a flavor to the malto-dextrin complementary to the appliqué to be applied to the container. Thus, for example, if the adhesive is used for adhering salt to the container, the malto-dextrin may be hydrated with a saturated sodium chloride solution (for example approximately 37.5 grams of sodium chloride per 100 ml water). Further, if the adhesive is used for adhering sugar to the container, the malto-dextrin may be hydrated with a saturated sucrose solution.

The saturated solutions for hydration also serve to help reduce dissolution of a salt, sugar or other water soluble appliqué when the appliqué comes into contact with the adhesive. This may be important to preserve the size of crystalline attractants that provide not only flavor but decorative value and texture. The composition of the adhesive or other applied bonding matrix for holding appliqué material is also selected to preserve color, texture and other attractive qualities of the appliqué material during and after curing. In particular, the formulations discussed above avoid significant degrading of the crystalline attractant appliqués discussed. Unless a particular mixing result on the rim is desired, the adhesive preferably does not affect the integrity of the appliqué material, although there will be several hours or days between preparation of the container with appliqué and its use.

A plasticizer, such as propylene glycol may further be added to the adhesive. An additional ingredient, such as a sugar alcohol, may further be added to reduce water activity and minimize possible microorganism growth.

As stated above, a curing means 420 may be used to cure the adhesive and appliqué. The curing means 420 used may depend on the adhesive and/or appliqué. For example, for chocolate or other fat-based material that is hot applied, cure may be via cooling. Such cooling may be achieved by applying streams of cooled, dry air or by a refrigeration chamber step. Conversely, an adhesive that is cold applied and contains water may be cured via heating. Such heating may comprise a heat-drying process, for example, via placement in a heated oven, passing through a heating unit on a process line, a microwave drying tunnel, or other chamber. Infrared light may also be used for curing. Performing curing rapidly in sequence after adhesive and appliqué are brought together may help retard undesired interactions. Any curing means suitable for the adhesive and appliqué may be used. Generally, the curing means affords curing of the adhesive and/or appliqué without degrading the container.

In other embodiments, the appliqué may be applied directly to the container without a separate adhesive application. This may be done where the appliqué itself is suitable for use as an adhesive. For example, the rim of the container may be dipped in warmed, liquid chocolate and the chocolate allowed to form up. Alternatively, this may be done by mixing an appliqué and adhesive into a homogenous mixture that may be applied to the container. Further, the adhesive may comprise the qualities associated with the appliqué and thus may be used as an appliqué with no further appliqué material being applied. For example, a lemon, lime, mint, licorice, or other flavored adhesive may be applied to the container.

If applied without an adhesive, the appliqué should have sufficient adhesive qualities to impart durability of the application of the appliqué to the container. In the example of chocolate applied to the container, the chocolate may alternately be used as an adhesive for a further appliqué. For example, a crushed candy may be used as an appliqué with the rim of the container being dipped in liquid chocolate and the crushed candy applied to the liquid chocolate. Alternatively, the appliqué attractant material can be formulated as a mixture including one of the adhesive materials mentioned above. This is then applied directly, and cured if necessary.

In a further embodiment, where the container is made of a plastic approved for prolonged food contact, the appliqué may be thermoformed into the plastic material of the container. Then the material of the container effectively serves as the adhesive matrix for the appliqué, such as embedded flavored salt or sugar crystals that have at least a portion of their surface available outside the thermo-formable material to provide flavor or other attractant qualities. Thus, effective bonding may be achieved using the tackiness of hot plastic to secure and/or embed an appliqué into the plastic. In this application localized heating may be applied to soften the thermo-formable material of a rim, with the softened rim then placed in a bed of salt or sugar crystals or other particulate attractant material that is not adversely affected by exposure to the heated thermo-formable material while it cools.

The embodiment of FIGS. 1a-1b illustrates an appliqué applied to the rim of a container. Alternately, the appliqué may be applied to other areas of the container. For example, the appliqué may be applied to all or a portion of the inside or the outside of the container at areas other than the rim of the container. Application to the inside of the container, in particular, may be done to provide a flavoring component to the container. Application to the outside of the container may be done to provide a decorative aspect to the container.

The appliqué may be applied to the container in any suitable manner. The manner of application may be determined by the desired characteristics of the container. In one embodiment, the appliqué is applied to each container (with or without adhesive) individually. In another embodiment, the appliqué (with or without adhesive) is applied to a nested stack of containers. As seen in FIG. 5a, a stack of containers 20, with rims 524 is treated with an appliqué delivered from multiple dispensers 522 in a dispenser stack 520. In the embodiment using an adhesive substrate 410 separate from an appliqué 412, each dispenser 522 may deliver both materials through separate applicator paths. To fully coat the rims 524, there is relative motion of the dispenser stack 520 and the rims 524, or the dispenser stack 520 is designed to surround the containers 20.

As shown in FIG. 5b, for application of the appliqué to a stack of containers 20 with rims 524, the stack may be held between rotatable fixtures 540, 542, rolled in contact with a container 530 of adhesive 532 and then rolled in the appliqué, or the container 530 may have a mixture of adhesive and appliqué attractant material. Alternatively, the adhesive and/or appliqué attractant material may be sprayed or extruded onto the stack of containers 20. As will be appreciated, some configurations of container may not be as easily handled in a stack. More specifically, some container configurations are not nestable (for example, the martini glass shown in FIG. 2b, unless made in two stem-bowl components, permitting bowls to be nested).

The following are a few examples of possible container products with various rim appliqués: disposable margarita cup with lime juice flavored adhesive and sea salt; disposable daiquiri cup with flavorless adhesive and plain or colored sugar crystals; disposable coffee cup with chocolate; disposable hot chocolate cup with mint chocolate; and holiday punch glass with seasonal color pattern in colored adhesive and colored sugar crystals.

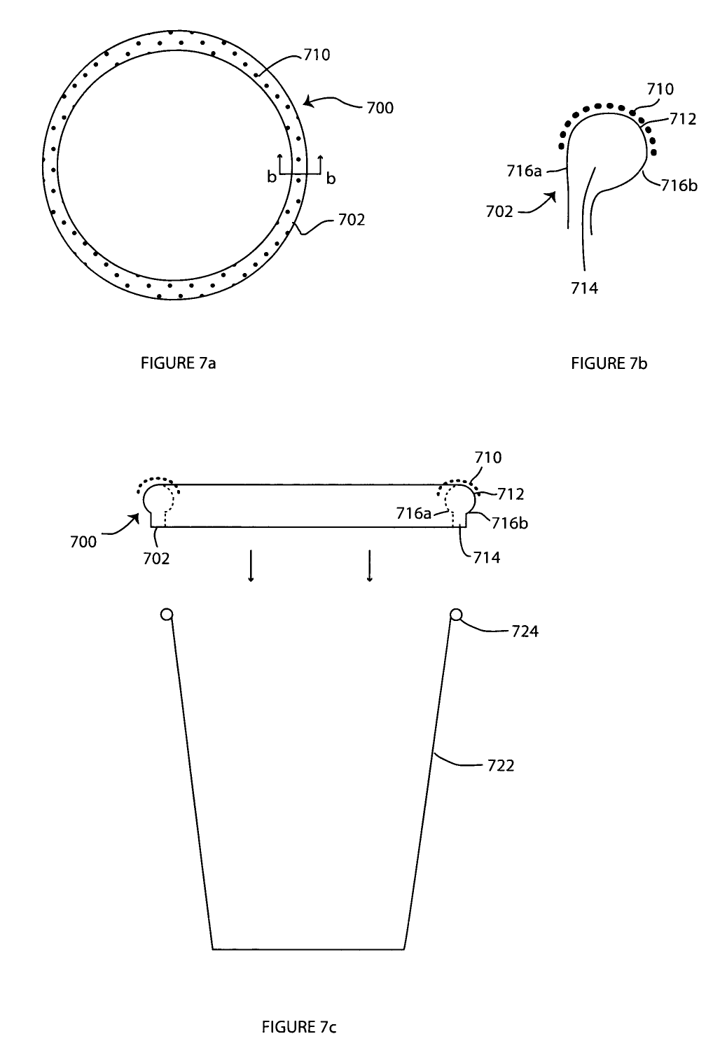

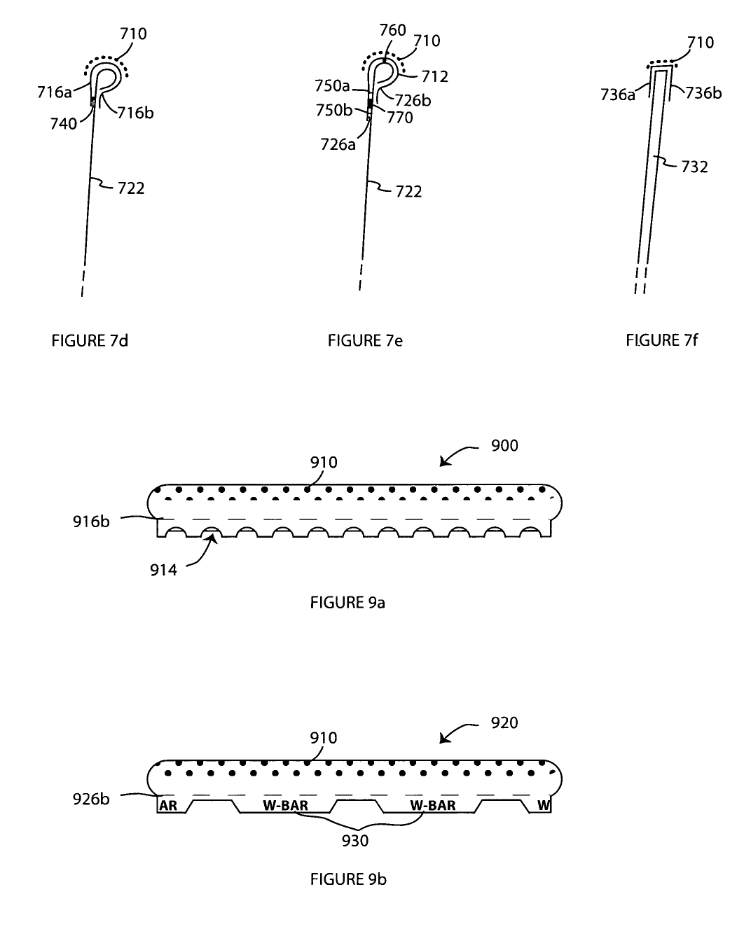

Overview of Rim Attachment with Appliqué. In a further embodiment, the appliqué is placed on a container rim attachment to be affixed to a container rim. Thus, only rim attachments with desired appliqués need to be shipped to a bar or other beverage service location and stored there, not entire containers. In addition, a disposable rim attachment may be affixed to a glass, china or other reusable container, resulting in less waste than if an entire container with appliqué were used for each beverage. As seen in FIGS. 7a-7c, a rim attachment 700 may comprise a carrier 702 generally in the form of a ring. The carrier 702 has an outer surface 712 to which an appliqué 710 as previously described above is applied and a rim receiving recess 714 formed by the configuration of the carrier's cross sectional profile. The rim attachment 700 is a separate annular unit that may be shipped and stored in a stack with other like annular units. In use, the rim attachment 700 is placed on the rim 724 of a container 722 by fitting the rim receiving recess 714 to the container rim and pressing the two together. The carrier 702 may be made of a resilient material formed with a cross-section as seen in FIG. 7b. The rim receiving recess 714 is thus formed as a space between the inner wall 716a and outer wall 716b of a channel, the walls 716a, 716b being connected by a middle section that forms the outer surface 712 to which the appliqué 710 is applied, using materials and methods as described above.

To deter liquid from traveling under the rim attachment 700 and dripping down the outside of the container 722, as seen in FIG. 7d the inner wall 716a may have a liquid barrier 740 in the form of an annular bead or protrusion from the inner wall 716a into the rim receiving recess 714. Barrier 740 forms a seal against the interior wall of a container 722 to which the rim attachment 700 is applied. This liquid barrier 740 may be integral to the inner wall 716a or may be inserted into the rim-receiving recess 714 as a separate ring. As seen in FIG. 7f, the inner and outer walls 736a and 736b, respectively, may be spaced apart so as to provide a tight friction or interference fit on a container 732 with a straight side and little or no lip at the rim or, as seen in FIGS. 7d and 7e, be spreadable and have resilience so as to allow a spring fit after being spread to fit over a rim with a lip. As seen in FIG. 7e, the rim attachment 700 may have an extended inner wall 726a opposite outer wall 726b to help provide stability or aid in making a liquid barrier. An extended inner wall may have two or more ribs 750a, 750b to form liquid barriers. Alternatively, as also shown in FIG. 7e, a liquid barrier rib 760 may be formed on the attachment's inner surface, opposite the outer surface 712 that carries the appliqué 710, or even as part of the outer wall 726b. In one embodiment, the inner wall 716a, 726a may be shortened so that the rim attachment 700 is held in place primarily by forces applied by the outer wall 716b, 726b to the container rim, much like a conventional beverage cup lid but with the center removed.

In the embodiment shown in FIG. 7e, the rim attachment 700 has an extended inner wall 726a that may be attached to a container 722 using a flavorless edible adhesive 770, which may be similar to the adhesives suggested above for adhering a particular appliqué to a container, except for retaining some tackiness to promote sealing when the rim attachment is placed on the rim. This adhesive may then serve as a liquid barrier.

Where beverage container sizes and lip formations are relatively standard, a bar or other beverage service location will be adequately equipped with a relatively small number of different rim attachments, each with a circumference and rim receiving recess profile that fits one of the standard containers. The containers receiving rim attachments 700 may be made of glass, plastic (including foam), ceramic, paper, metal or other known container materials.

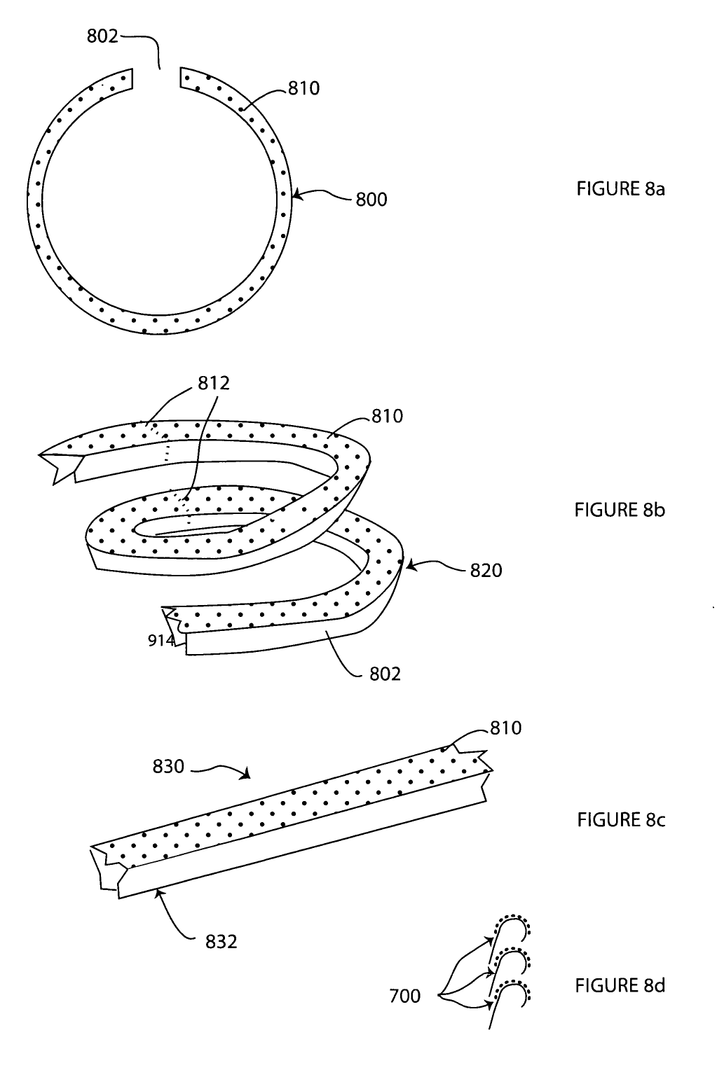

Size Adaptable Rim Attachments. Where container sizes are not standard, the rim attachments may be made adaptable to varying rim circumferences. FIG. 8a shows a rim attachment 800 in the form of a ring as in FIGS. 7a-7b but that has been cut to form an expansion gap 802 so that it may be expanded to fit a range of rim circumferences, simply by opening the gap 802 when the rim attachment 800 is applied to the container rim. FIG. 8b shows a coil 820 of rim attachment stock 802 with appliqué 810 that may be cut to size. If made sufficiently flexible, this stock 802 can be used to fit a wide range of rim circumferences. The stock 802 may be formed with weakened tear points 812 for a user to break off pieces that are a length corresponding to the rim circumference desired to be covered. Alternatively, the user may cut the stock 802 with scissors or a knife to make a suitable length. FIG. 8c shows a short exemplary section of linear carrier stock 832 with appliqué 810 that also may be broken or cut and is sufficiently flexible to be placed on the circular rim of a container. Such linear stock, if made highly flexible, might also be useful for glasses with square or other non-circular rims. In view of the greater amount of flexing to which these embodiments will be subjected in use, it is preferable that the appliqué be made with materials as described above that remain flexible after drying and/or curing and that do not lose excessive appliqué material upon flexing. FIG. 8d shows how rim attachments 700 (or 800, 820 and 830) with suitable profiles may be stacked or coiled so that the appliqué of one nests against and may receive some protection from the rim receiving recess of the one above it.

In a further embodiment shown in FIG. 9a, the rim attachment 900 with appliqué 910 can be made with an outer wall 916b of the rim receiving recess 914 made with a decorative edge pattern. In FIG. 9b is an embodiment of a rim attachment 920 having appliqué 910 with an outer wall 926b that has both a decorative edge pattern and a printed or embossed message or design 930, for example an establishment or brand name or a symbol. Such a configuration, when used with ring attachments of appropriate size, permits the beverage buyer to slip the ring attachment onto a wrist as a temporary accessory. Alternatively, the ring may be imprinted with a message either on a wall of the rim receiving recess or as part of the outer surface, to be revealed as the appliqué is consumed. Such a ring may also be attractive to be worn on the wrist. Consumers of beverages may wish to use the number of ring attachments worn to track or display beverage consumption.

The rim attachments of the preceding designs may also be formed with colors and with design configurations other than those specifically shown. For example the rim attachments may be formed in colors that match or contrast with the containers or with the appliqué. The rim attachment outer surface 712 (FIGS. 7b, 7c) that receives appliqué may be formed with a profile similar to those shown in FIGS. 3a-3f. The rim attachments may be formed with the same plastics discussed above for use in beverage containers with appliqués, such that the same materials discussed above for use in appliqués for container rims may be used in the rim attachments.

Although the invention has been described with reference to preferred embodiments, persons skilled in the art will recognize that changes may be made in form and detail without departing from the spirit and scope of the invention.

1. A container rim attachment having a preapplied appliqué comprising:
a carrier with an outer surface and a rim-receiving recess; and
an attractant appliqué applied to the outer surface of the carrier such that there is an adherence between the appliqué and the outer surface, wherein the adherence between the appliqué and the carrier is sufficient to withstand conditions associated with shipping, storage, or handling of the carrier and appliqué without substantial appliqué degradation.

2. The container rim attachment of claim 1, wherein the appliqué is edible.

3. The container rim attachment of claim 2, wherein the appliqué is selected from the group consisting of salts, sugars, spices, nuts, seeds, fruits, vegetables, herbs, flowers, nutraceuticals, vitamins, and candies.

4. The container rim attachment of claim 1, wherein the carrier is plastic.

5. The container rim attachment of claim 1, further comprising an adhesive between the appliqué and the carrier, wherein the adhesive imparts durability to the adhered appliqué.

6. The container rim attachment of claim 5, wherein the adhesive is carbohydrate-based, lipid-based, or protein-based.

7. The container rim attachment of claim 5, wherein the adhesive is a maltodextrin-corn syrup blend.

8. The container rim attachment of claim 1, wherein the appliqué comprises an adhesive.

9. The container rim attachment of claim 1, wherein the rim receiving recess has opposed surfaces for a friction fit on opposed surfaces adjacent the rim of a container.

10. The container rim attachment of claim 9, wherein the rim receiving recess has a liquid barrier for deterring liquid flow across the rim receiving recess.

11. The container rim attachment of claim 1, wherein the carrier is configured as a closed ring.

11. The container rim attachment of claim 1, wherein the carrier is configured as a ring with an expansion gap.

12. The container rim attachment of claim 1, wherein the carrier is configured as an extended length of carrier stock.

13. A container rim attachment having a preapplied appliqué comprising:
a plastic carrier having an outer surface and a rim-receiving recess; and; and
an edible appliqué applied to the carrier such that there is an adherence between the appliqué and the rim;
wherein the adherence between the appliqué and the carrier is sufficient to withstand conditions associated with shipping and handling of the carrier and appliqué without substantial appliqué degradation.

14. The container rim attachment of claim 13, wherein the appliqué is selected from the group consisting of salts, sugars, spices, nuts, seeds, fruits, vegetables, herbs, flowers, nutraceuticals, vitamins, and candies.

15. The container rim attachment of claim 13, further comprising an adhesive between the appliqué and the carrier, wherein the adhesive imparts durability to the adherence of the appliqué.

16. The container rim attachment of claim 15, wherein the adhesive is carbohydrate-based, lipid-based, or protein-based.

17. The container rim attachment of claim 15, wherein the adhesive is a maltodextrin-corn syrup blend.

18. The container rim attachment of claim 13, wherein the appliqué comprises an adhesive.

19. The container rim attachment of claim 13 wherein the appliqué comprises an adhesive containing an appliqué material and diluted to a selected viscosity by use of a solution saturated with a material that retards dissolution of the appliqué material.

20. The container rim attachment of claim 19 wherein the solution is saturated with salt.

21. The container rim attachment of claim 19 wherein the solution is saturated with sugar.

22. The container rim attachment of claim 13 wherein the adhesive is a malto-dextrin-corn syrup blend with negligible discernible flavor.

23. A container rim attachment having a preapplied appliqué comprising:
a carrier; and
an appliqué applied to a portion of the carrier;
a bonding between the appliqué and the portion of the carrier, the bonding being effective for preserving the appliqué and bonding reasonably intact under conditions associated with shipping and handling of the carrier.

24. A method for making a container rim attachment having a pre-applied appliqué comprising:
providing a carrier with a rim receiving recess; and
applying an appliqué to at least a portion of the carrier; and
effecting bonding between the appliqué and an outer surface of the carrier, the bonding being sufficient to withstand conditions associated with handling of the carrier without substantial appliqué degradation.

25. The method of claim 24 wherein the step of effecting bonding comprises applying an adhesive and curing the adhesive.

26. The method of claim 24 wherein the step of effecting bonding comprises curing an appliqué that adheres to the rim attachment during its application.

27. The method of claim 24 wherein the step of effecting bonding comprises applying an appliqué to adhere to a softened, thermo-formable material of the carrier.
